(19) United States
(12) Patent Application Publication
(10) Pub. No.: US 2019/0305303 A1
(43) Pub. Date: Oct. 3, 2019

(54) BATTERY PACKAGE

(71) Applicant: Lenovo (Singapore) Pte. Ltd., Singapore (SG)

(72) Inventors: Bouziane Yebka, Apex, NC (US); Joseph Anthony Holung, Wake Forest, NC (US); Philip John Jakes, Durham, NC (US); Tin-Lup Wong, Chapel Hill, MC (US)

(21) Appl. No.: 15/940,689

(22) Filed: Mar. 29, 2018

(51) Int. Cl. H01M 4/36; H01M 10/0525; H01M 2/10; H01M 2/02

(52) U.S. Cl. CPC H01M 4/366; H01M 10/0525; H01M 2220/30; H01M 2/0287; H01M 2/1061

(57) ABSTRACT

A battery package can include a battery that includes at least one lithium-ion cell; and a package material that includes at least one layer of fiberglass.

### TECHNICAL FIELD

Subject matter disclosed herein generally relates to battery packages.

### BACKGROUND

A battery can include one or more electrochemical cells and formed as a battery package. As an example, an electrochemical cell in a battery package can be a lithium-ion cell. Such a battery package may be installed in a battery bay of a device such as, for example, a computing device.

### SUMMARY

A battery package can include a battery that includes at least one lithium-ion cell; and a package material that includes at least one layer of fiberglass. A battery package can include a battery that includes at least one lithium-ion cell and at least one layer of rigid support material; and a package material having a thickness less than approximately 60 microns and greater than approximately 30 microns. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a battery and an example of circuitry;

FIG. 2 is a diagram of various components of a device powered by one or more batteries;

FIG. 3 is a diagram of various components of a device powered by one or more batteries;

FIG. 4 is a series of diagrams of an example of a battery package, some examples of battery package geometries and an example of package material;

FIG. 5 is a series of diagrams of examples of package material;

FIG. 6 is a series of diagrams of an example of a battery package;

FIG. 7 is a series of diagrams of examples of a battery package;

FIG. 8 is a series of diagrams of examples of package material;

FIG. 9 is a series of diagrams of examples of a battery package;

FIG. 10 is a series of diagrams of examples of package material;

FIG. 11 is a series of diagrams of examples of package material;

FIG. 12 is a series of photographs of examples of fiberglass;

FIG. 13 is a diagram of examples of devices; and

FIG. 14 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

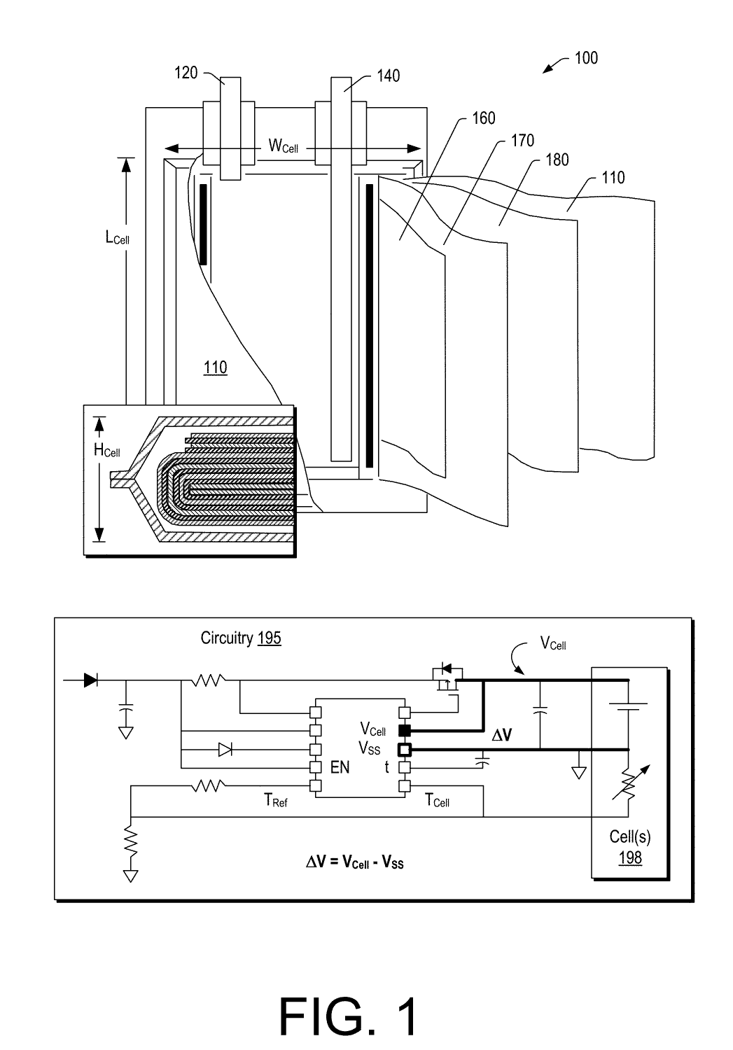

FIG. 1 shows an approximate cut-away view of an example of a battery 100 that includes a casing 110 and a positive tab 120 and a negative tab 140, for example, to operatively couple the battery 100 to circuitry. The casing 110 may include a cell region defined by a cell length (L_{Cell}), a cell width (W_{Cell}) and a cell height (H_{Cell}). As an example, the cell region may include one or more electrochemical cells. As an example, an electrochemical cell may be formed in part by a cathode 160, a separator 170 and an anode 180. Such components may be “folded”, for example, to form a stack (e.g., “jelly roll”) that may be housed in the cell region of the casing 110. As shown in the example of FIG. 1, in an approximate cross-sectional view, the height (H_{Cell}) of the cell region of the casing 110 may be defined in part by thicknesses of the cathode 160, the separator 170 and the anode 180 as well as, for example, by stacking of such components (e.g., winding in a roll or other configuration). As an example, a cathode formed of electrode material, an anode formed of electrode material and a separator formed of separator material along with collector materials may be layered and stacked, for example, by folding in a zigzag orientation, folding in a clockwise roll orientation, folding in a counterclockwise roll orientation, etc.

As an example, a cell can include an anode collector material that includes, for example, copper; an anode electrode material that includes lithium and carbon (e.g., Li_{y}C); a separator material configured for passage of lithium ions (e.g., in electrolyte); a cathode electrode material that includes lithium and metal oxide (e.g., Li₁₋ₓCoO₂); and a cathode collector material that includes, for example, aluminum. While carbon, cobalt, copper and aluminum are mentioned, other materials may be employed to form a lithium-ion cell.

As to the terms “anode” and “cathode”, these may be defined based on discharge, for example, where lithium ions migrate in a direction from a carbon-based matrix towards a metal oxide-based matrix. In other words, when a lithium-ion based cell is discharging, a positively charged lithium ion may be extracted from anode electrode material (e.g., graphite lattice) and inserted into cathode electrode material (e.g., into a lithium containing compound); whereas, when such a cell is charging, the reverse process may occur.

As an example, positive electrode material (e.g., cathode electrode material) may include LiCoO₂, LiMn₂O₄ or other compound. As an example, separator material may include a conducting polymer electrolyte (e.g. polyethyleneoxide “PEO”, etc.). For example, a separator material may include polymer that provides for conduction of lithium ions (e.g., a lithium-ion conductive polymer material). As an example, negative electrode material (e.g., anode electrode material) may include ionizable lithium metal, a carbon-lithium intercalation compound, etc.

As an example, a lithium-ion battery may include one or more cells where each cell includes an anode, a cathode and electrolyte, which may be a polymeric material or provided in a polymeric matrix. As an example, a cell may include an anode electrode material that includes carbon, a cathode electrode material that includes a metal oxide, and a separator material that includes polymer.

As an example, active electrode particles may be for a cathode to form cathode electrode material. For example, consider particles that include one or more of lithium cobalt oxide (LiCoO₂), lithium nickel oxide (LiNiO₂), lithium manganese oxide (LiMn₂O₄), and lithium iron phosphate (LiFePO₄).

As an example, positive active electrode particles may include lithium and metal oxide, for example, represented by LiₓM¹_{y}M²_{1-y}O₂ where 0.4≤x≤1; 0.3≤y≤1; M¹ is at least one selected from the group consisting of Ni and Mn; and M² is at least one selected from the group consisting of Co, Al, and Fe. As an example, positive active electrode particles may include lithium and metal oxide, for example, be represented by one of the following: LiNiₓCo_{y}Al_{z}O₂, where 0.7≤x≤1; 0≤y≤0.3; 0≤z≤0.03; and 0.9≤x+y+z≤1.1; LiNiₓCo_{y}Mn_{z}O₂, where 0.3≤x≤0.6; 0≤y≤0.4; 0.3≤z≤0.6; and 0.9≤x+y+z≤1.1; LiₓMn_{z}O₂, where 0.4≤x≤0.6; and 0.9≤z≤1; or LiFeₓCo_{y}Mn_{z}O₂, where 0.3≤x≤0.6; 0.1≤y≤0.4; 0.3≤z≤0.6; and 0.9≤x+y+z≤1.1.

As an example, active electrode particles may be for an anode to form anode electrode material. For example, consider particles that include one or more of carbon lithium and lithium titanate. As to lithium titanate, consider, for example: Li₂TiO₃; Li₄TiO₁₂; Li₄Ti₅O₁₂.

As an example, a cell may include electrolyte in a polymeric matrix. For example, consider an electrolyte that includes Li(ClO₄)₂ in polycarbonate/tetrahydrofuran (PC/THF) (e.g., about 0.4 M) or other polymeric matrix.

FIG. 1 also shows an example of circuitry 195 for managing one or more electrochemical cells 198. As an example, the circuitry 195 and the cell(s) 198 can be a battery assembly; noting that a battery assembly can include, alternatively or additionally, one or more other types of circuitry.

A charge rate and/or a discharge rate may be referred to as a C-rate and be specified using a numeric value followed by the capital letter “C”. A C-rate specifies the speed a battery is charged or discharged. Speed may be relatively constant for an application(s), function(s), etc., or, for example, speed may vary with respect to time as application(s), function(s), etc., change. As to C-rate, at 1 C, a battery charges and discharges at a current that is on par with a marked Ah rating (e.g., as specified by a manufacturer, etc.). At 0.5 C, the current is half and the time is doubled, and at 0.1 C the current is one-tenth and the time is 10-fold.

The capacity of a battery may be rated with respect to a C-rate, for example, a battery rated at 1 C means that a fully charged battery rated at 1 Ah can be expected to provide 1 A for one hour (h). The same battery discharging at 0.5 C can be expected to provide 500 mA for two hours (2 h), and at 2 C, 2 A for 30 minutes (0.5 h).

As to the term load, it defines the current that is drawn from a battery. Internal battery resistance and depleting state of charge (SOC) can cause voltage to drop under load, which can in some instances trigger an end of discharge (e.g., termination of discharge or discharging). Power relates to current delivery measured in watts (W); energy is the physical work over time measured in watt-hours (Wh).

As to the terms specific energy and gravimetric energy density, these define battery capacity in weight (Wh/kg); whereas, the term volumetric energy density defines battery capacity with respect to volume in liters (Wh/l). As an example, a lithium ion battery may be of a volumetric energy density that is in a range of about 10 Wh/l to more than 1,000 Wh/l.

As mentioned, a cell (e.g., or cells) may be characterized, for example, as to specific energy (e.g., Wh/kg or MJ/kg), energy density (Wh/l or MJ/l), specific power (W/kg), etc. As an example, a region of a battery with one or more cells may include L_{Cell} and W_{Cell} dimensions (e.g., rectangular dimensions), for example, with a L_{Cell}/W_{Cell} ratio in a range of about 1 to about 5. As an example, consider a cell (or cells) with dimensions of about 120 mm (L_{cell}) by about 100 mm (W_{cell}) where, in combination with a height (H_{Cell}), a volume (Vol_{Cell}) may be calculated. As an example, with a volume (Vol_{Cell}) and energy density (ED in Wh/l), an energy value (e.g., Wh) may be determined for the battery.

As an example, a battery with a volume of about 43 ml (˜43,000 cubic mm) and a thickness (H_{Cell}) of about 3.6 mm (e.g., with L_{Cell} and W_{Cell} of about 120 mm and about 100 mm) may have an energy density of about 480 Wh/l. In terms of energy, such a battery may be capable of storing about 21 Wh, which may be sufficient to power 2.6 W circuitry for about 8 hours (e.g., circuitry operational time).

A cell or cells may be referred to as a lithium-ion battery or a lithium-ion polymer battery or a lithium-polymer battery (e.g., “LiPo battery” or “LiPo cell”). LiPo cells are sometimes referred to as laminate cells, which may be configured very thin or quite large depending on their intended use. One or more LiPo cells may be encased in a flexible aluminum foil laminate pouch (e.g., with a thickness of the order of about 0.1 mm; see, e.g., the casing 110 of the battery 100 of FIG. 1). LiPo cells may include a stacked construction formed by stacking materials that include electrode and electrolyte materials in a flat sandwich (e.g., defined by length, width and height dimensions). Stacked layers may be packed in a package (see, e.g., the casing 110 of FIG. 1) in a flat, rolled or other configuration. LiPo cell capacities may include capacities in a range, for example of about 50 mA·hrs (e.g., for a small cell such as for a Bluetooth headset) to about 10 A·hrs or more for an electric vehicle (e.g., electric or hybrid).

A package (e.g., a battery package) provided in a pouch format or a prismatic format may expand, for example, when the state-of-charge (SOC) level of a battery is high (e.g., overcharge) or when the SOC of a battery is low (over-discharge). A Li-ion battery may be managed to varying extent by management circuitry.

As to protection features, a cell temperature sensor bias feature (see, e.g., T_{Ref} in the circuitry 195 of FIG. 1) may provide for a voltage reference to bias external thermistor for continuous cell temperature monitoring and prequalification while a cell temperature sensor input feature (see, e.g., T_{Cell} in the circuitry 195 of FIG. 1) may provide for input for an external thermistor for continuous cell temperature monitoring and prequalification (optionally may be disabled by applying a set voltage) and safety timers (e.g., preconditioning, fast charge, elapsed time termination, etc.) may be scaled by a capacitor. A temperature-sensing circuit may have its own reference such that it is immune to fluctuations in the supply voltage input (e.g., where the temperature-sensing circuit is removed from the system when no supply is applied, eliminating additional discharge of cell(s)).

As to logic, a logic enable feature may provide for input that, for example, forces charge termination, initiates charge, clears faults or disables automatic recharge. For example, a logic-enable input pin (EN in the circuitry 195 of FIG. 1) may provide for features to terminate a charge anytime during the charge cycle, initiate a charge cycle or initiate a recharge cycle. A logic input (e.g., high or low) may signal termination of a charge cycle. A cell voltage sense can provide for monitoring voltage at, for example, a positive terminal of a cell (e.g., for single, dual, etc., series cell packs with coke or graphite anodes).

Management circuitry may be configured to manage, to varying extent, state-of-charge (SOC) mismatch and capacity/energy (C/E); noting that as the number of cells and load currents increase, the potential for mismatch also increases. Though SOC may be more common, each type of mismatch problem limits capacity (mA·h) of a pack of cells to capacity of the weakest cell.

While a LiPo cell package may be flexible, bending is generally to be minimized or avoided as bending may bring the housed anode and cathode materials closer together, which can cause preferential plating and shorting, which can reduce cycle life and present a potential safety hazard.

Various phenomena can cause gassing or gas expansion of a LiPo cell package. For example, a puncture can cause an internal short circuit, which may cause the cell to get hot. Further, even if a cell does not short, a leak may allow moisture in, which may eventually cause self-discharge. A cell may also generate gas from reaction of an anode with moisture.

Another issue for LiPo packages can be edge shorting. Edge shorting can occur, for example, where an aluminum layer of a package is conducting and, if exposed at a cut edge of the package, can short out via contact with one or more neighboring components. Yet another issue is related to internal corrosion reactions in a cell, which can occur if tabs to an aluminum layer are shorted, which may happen, for example, if one or more tabs are bent over an edge of a package.

A lithium-ion battery can expand and/or contract responsive to various conditions. A lithium-ion battery may “breathe” and may “swell” where breathing and swelling may be viewed as two types of phenomena. As to breathing, it can be cyclic in that a battery can expand and contract. As to swelling, it can be trending in that a battery can expand and gradually increase in one or more dimensions (e.g., battery thickness). As an example, for a battery that has a substantially rectangular footprint and a manufactured thickness in a direction normal to a plane of the substantially rectangular footprint, during operation of the battery, breathing may occur that can be characterized as a breath percentage of the manufactured thickness and swelling may occur that can be characterized as a swell percentage of the manufactured thickness. In such an example, during the lifetime of use of the battery, the swell percentage can exceed the breath percentage.

A device that includes a battery package in a battery bay may be subjected to one or more quality control processes. Such processes can include apply force to a device, stepping or standing on the device (e.g., mass in excess of 50 kg, etc.), dropping the device at an angle or flat onto a hard surface (e.g., from a hip height or higher), thermal shock (e.g., rapid heating and/or rapid cooling), etc.

During a quality control process or an accident, force may cause a battery package to become dented, punctured, or otherwise deformed. For example, applied force may be sufficient to cause a component of the device to contact the battery package where such contact deforms the battery package. In such an example, the component may be spaced apart from the battery package in a normal state by, for example, a gap distance, where the applied force closes the gap distance such that the component contacts the battery package. The amount and/or type of damage may depend on the shape and/or the type of material of the component. For example, if the component is stamped metal with a sharp edge, the component may puncture a battery package; whereas, if the component is a contoured soft plastic, the component may dent the battery package (e.g., make an indentation in the battery package).

A battery package may be subjected to one or more quality control processes that may utilize one or more instruments, for example, to measure force and associated deformation. Consider an Instron machine that can be utilized to a force applicator, which may take one or more forms. As an example, such a machine may be utilized with a tool that can indent a battery package. Such an approach may provide for force per unit area determinations and/or “hardness” determinations of a battery package (e.g., consider durometer values).

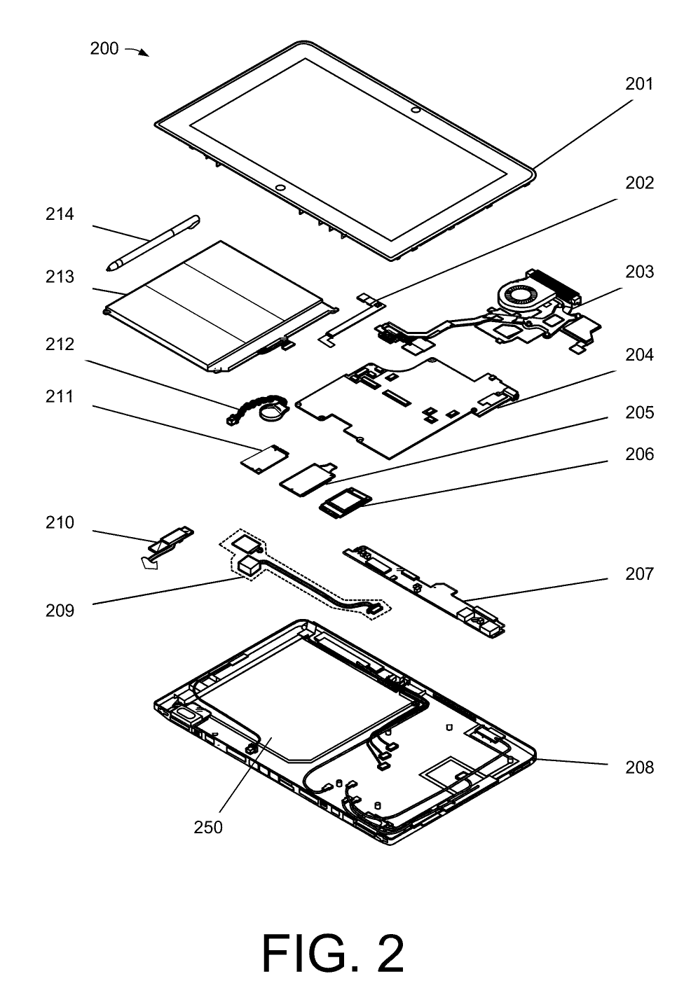

FIG. 2 shows an example of a device 200 that includes an LCD assembly 201, a camera assembly 202, a fan assembly 203, a board 204 (e.g., a circuit board, a system board, a motherboard, etc.), a wireless WAN card 205, a wireless LAN card 206, an I/O board 207, a cover assembly 208, a DC cable assembly 209, a communication card 210, a solid-state drive 211, a battery package 213, a stylus 214 and a battery bay 250. In the example of FIG. 2, the board 204 may include a processor and memory, which may be configured to store instructions accessible by the processor and, for example, executable by the processor to perform one or more tasks. In the example of FIG. 2, the battery package 213 may include multiple cells. For example, the battery package 213 may include three sets of cells (e.g., or three cells) such that one is in the middle and surrounded by two others (e.g., two neighbors). In an assembled state, the battery package 213 can be disposed in the battery bay 250.

In the example of FIG. 2, the battery package 213 can be adjacent to various components. Where the device 200 is subject to pressure, one or more of such components may contact the battery package 213 and, for example, deform the battery package 213. As explained, deformation of a battery package may cause internal damage where materials inside the battery package are squeezed closer together and/or thinned. Where a puncture occurs, consequences may include leakage, undesirable chemical reactions, etc.

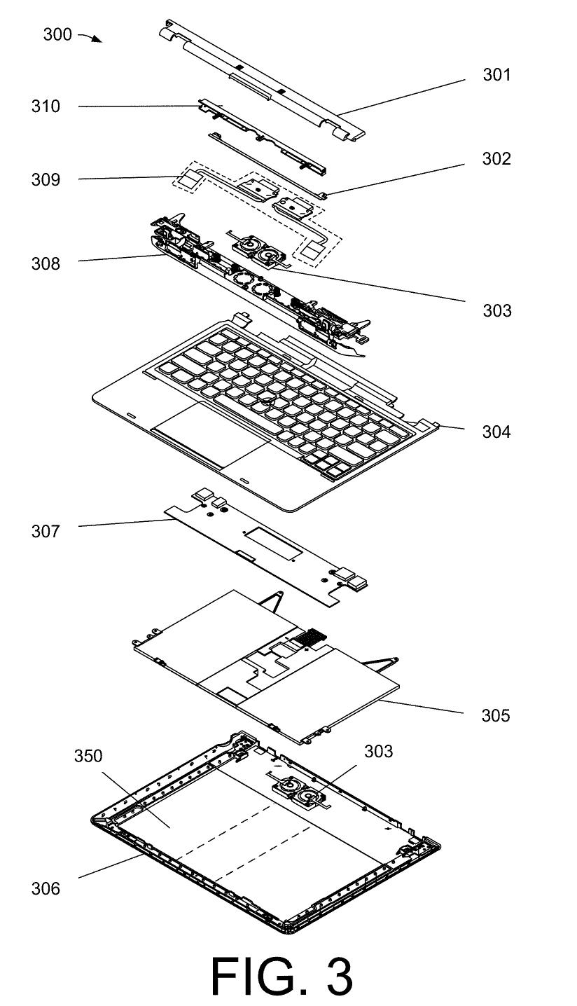

FIG. 3 shows an example of a device 300. As an example, the device 300 may be operatively coupled to the device 200. In the example of FIG. 3, the device 300 includes a cover and hinge assembly 301, a link structure 302, a fan assembly 303, a keyboard assembly 304, a battery package 305, a base cover 306, an I/O board 307, a hinge assembly 308, connectors 309, a connectors cover 310, and a battery bay 350. In the example of FIG. 3, the battery package 305 may include multiple cells. For example, the battery package 305 may include two sets of cells (e.g., or two cells). In an assembled state, the battery package 305 can be disposed in the battery bay 350.

In the example of FIG. 3, the battery package 305 can be adjacent to various components. Where the device 300 is subject to pressure, one or more of such components may contact the battery package 305 and, for example, deform the battery package 305. As explained, deformation of a battery package may cause internal damage where materials inside the battery package are squeezed closer together and/or thinned. Where a puncture occurs, consequences may include leakage, undesirable chemical reactions, etc.

A battery package can be secured to a housing (e.g., a surface of a battery bay) via an adhesive material. For example, in FIG. 2, the battery package 213 can be secured in the battery bay 250 by adhesive that binds to the battery package 213 and to the cover assembly 208; and, in FIG. 3, the battery package 305 can be secured in the battery bay 350 by adhesive that binds to the battery package 305 and to the base cover 306. In such examples, the cover assembly 208 can be or include a housing wall and the base cover 306 can be or include a housing wall.

An adhesive can be a substance that is applied to a surface of a component to bind the component to a surface of another component. As an example, an adhesive may be applied to a surface of one component and a surface of another component to bind the surfaces together. As an example, an adhesive or adhesives may be at an interface between two components. As an example, a component may be a substrate with respect to an adhesive, for example, an adhesive can bond two substrates. As an example, a stack may be defined by materials and components. For example, a stack may include a wall, adhesive and a battery (e.g., a battery package).

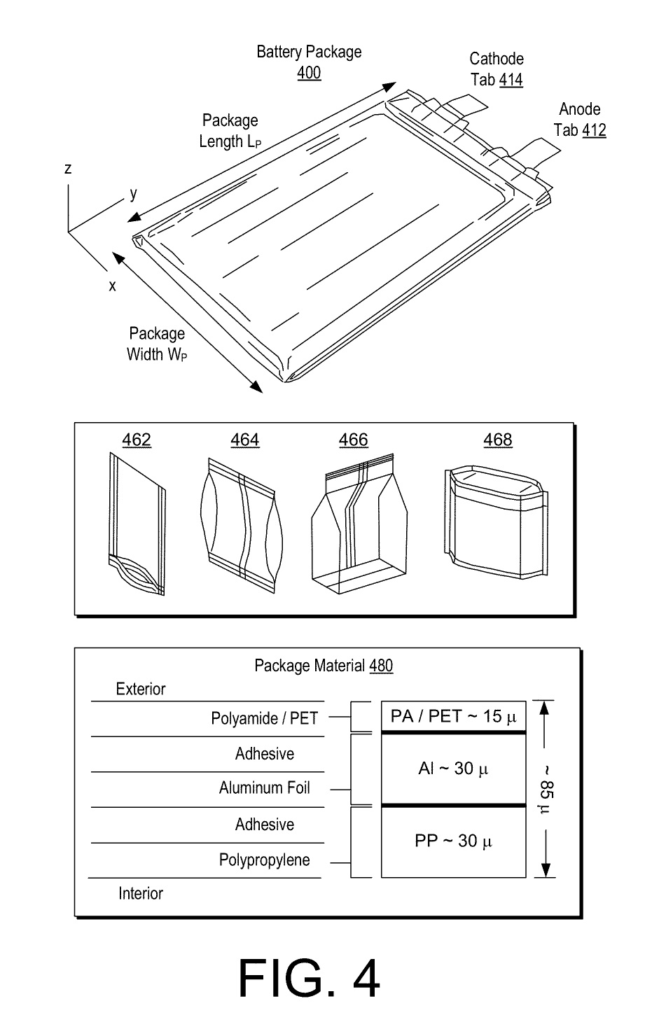

FIG. 4 shows an example of a battery package 400, some examples of battery package geometries 462, 464, 466 and 468, and an example of package material 480.

As shown in FIG. 4, the lithium-ion battery package 400 includes an anode tab 412 and a cathode tab 414. FIG. 4 includes a Cartesian coordinate system with x, y and z coordinate axes. The battery package 400 may be defined by a package length L_{P} along the y-axis and a package width W_{P} along the x axis; noting that the battery package 400 may also be defined by a package height, for example, along the direction of the z-axis. Depending on geometry, package height can be package thickness (e.g., thickness as measured along the z-axis for the battery package 400). The example battery package geometries 462, 464, 466 and 468 may be defined with respect to a coordinate system such as, for example, the Cartesian coordinate system as shown in FIG. 4.

As to the package material 480, it is a composite material in that it is formed from a variety of different materials. Such a composite material can be a laminate material in that it includes multiple layers where the multiple layers include two or more different materials. When formed as a package for a battery (e.g., a battery package), the package may be referred to as a laminate package or laminate material package or laminate material battery package.

In the example of FIG. 4, from exterior to interior, the example package material 480 includes a polyamide layer, an adhesive layer, an aluminum foil layer, an adhesive layer and a polypropylene layer. The polyamide layer may have a thickness of about 0.025 mm, adhesive layer may be a polyester-polyurethane adhesive applied at about 4 g·m⁻², the aluminum foil layer may have a thickness of about 0.040 mm, the second adhesive layer may be a urethane-free adhesive applied at about 2 g·m⁻², and the polypropylene layer may have a thickness of about 0.040 mm. Overall thickness may be about 100μ.

As an example, a package material may include polyethylene terephthalate (PET), aluminum (Al) and polypropylene (PP) where, for example, the PET forms a layer with a thickness of approximately 15μ, the Al forms a layer with a thickness of approximately 30μ and where the PP forms a layer with a thickness of approximately 30μ. Such a package material may have an overall thickness of approximately 85μ.

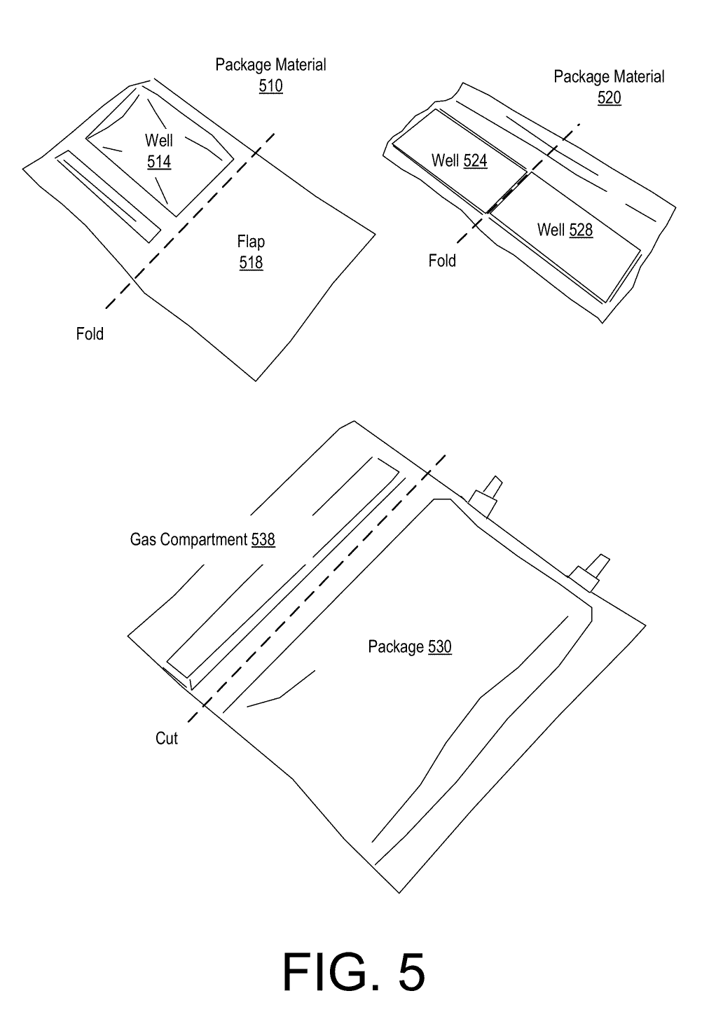

FIG. 5 shows an example of packaging material 510 that includes a well 514 to be covered by folding of a flap 518 over the well 514 to package a battery, an example of packaging material 520 that includes upper and lower well portions 524 and 528 to be folded to package a battery and an example of a package 530 that packages a battery, as formed using the packaging material 510, where a gas compartment 538 may be formed.

A laminate material for forming a package can possess various material properties such as being sufficiently flexible for one or more of manipulation, cutting, sealing, folding etc.; being sufficiently strong (e.g., with withstand denting, an amount of abuse, etc.); being sufficient compatible with chemicals (e.g., lithium battery chemistry, inorganic electrolyte, etc.).

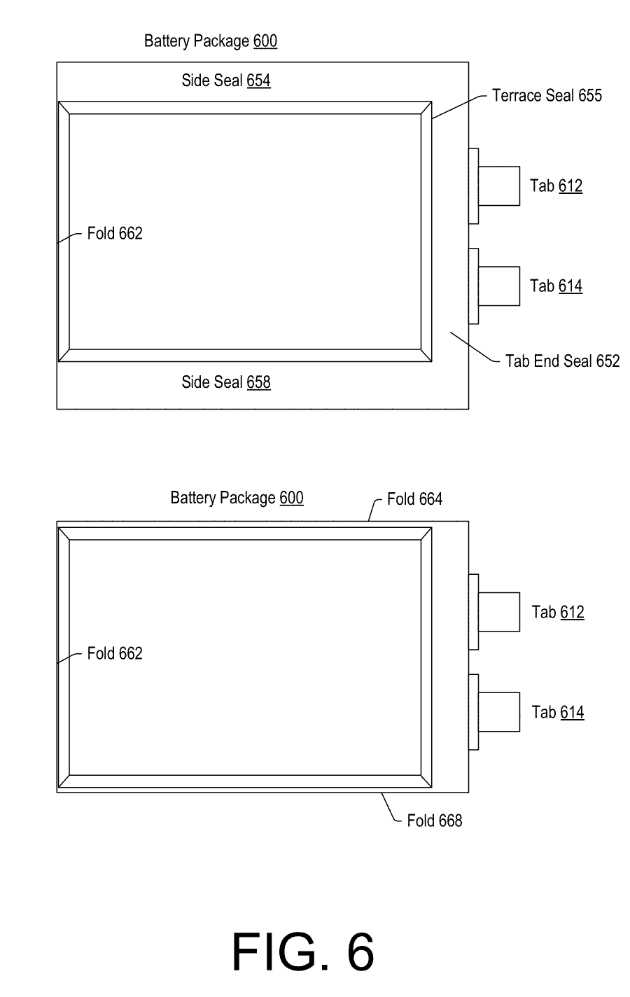

FIG. 6 shows an example of a battery package 600 that includes tabs 612 and 614 and various seals 652, 654, 655 and 658 and folds 662, 664 and 668. As shown, a seal may be a side seal, a terrace seal or a tab end seal. As shown, a fold may be an end fold or a side fold.

In the example of FIG. 6, the top plan view shows material that can be defined as side material. As explained with respect to the examples of FIG. 5, package material can include a well and a flap where a fold is made to cover a battery disposed in the well with the flap. After the flap is folded over to cover the well, the package material to the sides of the well can be utilized for forming seals to the sides of the well. Once sealed, folds and/or cutting may occur as to the side material. For example, as shown in FIG. 6, the side seal 654 is folded to form the fold 664 and the side seal 658 is folded to form the fold 668. As an example, cutting may occur to trim package material that may be excess where cutting occurs in a manner that does not affect the side seals.

A packaging process where a battery is packaged by packaging material can aim to closely package the battery such that voids are reduced, dead areas, wasted space, etc. A packaging process can utilize various types of equipment, some of which may be intended to contact packaging material and some of which may inadvertently contact packaging material. In either instance, contacting may occur in a manner that may possible compromise the packaging material, whether to cause the packaging material (or battery package) to be rejected or to diminish lifetime of a battery package or increase risk of failure of a battery package.

As explained with respect to the equipment of FIGS. 3 and 4, certain precautions may be taken when utilizing a flexible battery package. Such precautions can be taken with respect to components of a device, assembly of a device, shipping of a device, use of a device, transport of a device, recycling of a device, disposal of a device, etc.

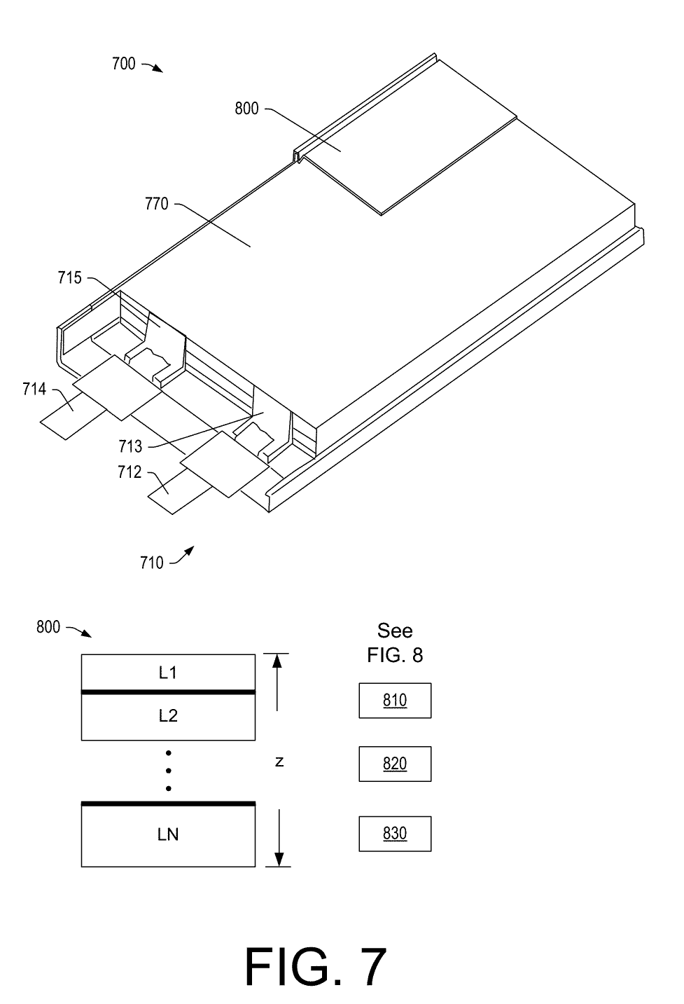

FIG. 7 shows an example of a battery package 700 that includes a battery 710, tabs 712 and 714 and electrical contact material 713 and 715, which are in electrical contact with anodes and cathodes and the tabs 712 and 714, respectively. Also shown in FIG. 7 is separator material 770 and package material 800, which includes various layers such that it is a laminate (e.g., a laminated package material). In FIG. 7, the package material 800 encases the battery 710, which includes the separator material 770.

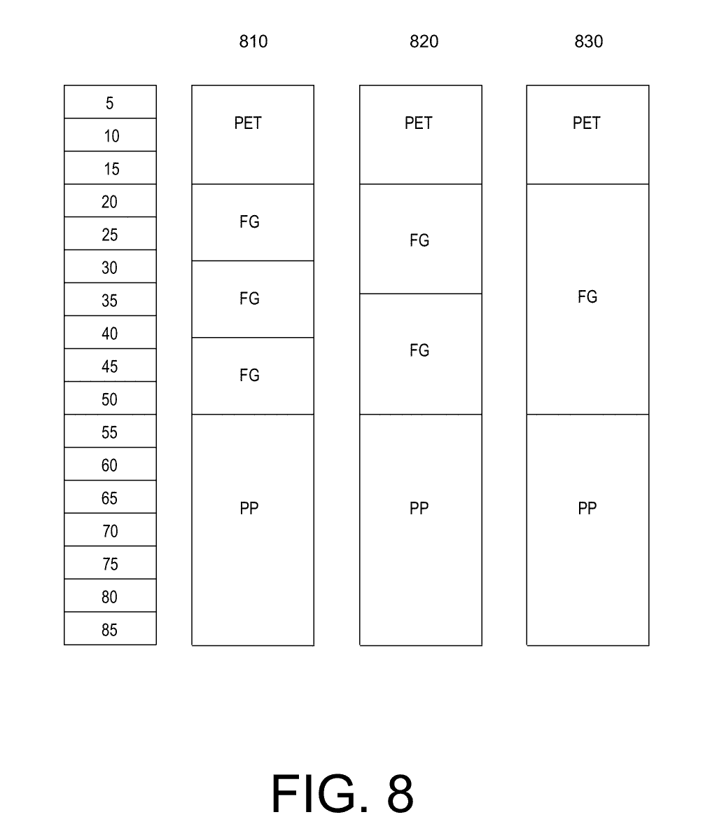

FIG. 8 shows some examples of package material 810, 820 and 830. The package material 800 of the battery package 700 can include, for example, one of 810, 820, or 830.

FIG. 8 shows package materials 810, 820 and 830; noting that one or more additional materials may be included. For example, one or more adhesives may be included at one or more interfaces to bind material utilized.

In the examples of FIG. 8, the package materials 810, 820 and 830 can include one or more types of glass fiber, for example, as fiberglass. Fiberglass may be a fiber reinforced polymer made of plastic reinforced by glass fibers. In such an example, plastic may be a thermosetting plastic (e.g., epoxy, polyester- or vinylester) or a thermoplastic.

As an example, glass fibers may be made of one or more of various types of glass depending upon the fiberglass use. Such glasses include silica or silicate, for example, with varying amounts of oxides of calcium, magnesium, and sometimes boron.

E-glass is an alumino-borosilicate glass, for example, with less than about 1% w/w alkali oxides (e.g., optionally used in a glass-reinforced plastic). Some examples of other types of glass include A-glass (alkali-lime glass with little or no boron oxide), E-CR-glass (electrical/chemical resistance; alumino-lime silicate with less than about 1% w/w alkali oxides, with high acid resistance), C-glass (alkali-lime glass with high boron oxide content, used for glass staple fibers and insulation), D-glass (borosilicate glass, named for its low dielectric constant), R-glass (alumino silicate glass without MgO and CaO with high mechanical requirements as reinforcement), and S-glass (alumino silicate glass without CaO but with high MgO content with high tensile strength).

Silica (silicon dioxide), when cooled as fused quartz into a glass with no true melting point, can be used as a glass fiber for fiberglass, but has the drawback that it must be worked at very high temperatures. To lower the work temperature, other materials may be introduced as “fluxing agents” (e.g., components to lower the melting point). E-glass (“E” because of initial Electrical application), is alkali free and tends to be susceptible to chloride ion attack (e.g., consider exposure to salt water). S-glass (“S” for “stiff”) may be used when tensile strength (high modulus) is desired; noting that R-glass, “R” for “reinforcement” may be a designator. C-glass (“C” for “chemical resistance”) and T-glass (“T” is for “thermal insulator” may resist some types of chemical attack. C-glass was developed to resist attack from chemicals, mostly acids that destroy E-glass. Glass fibers can have limited solubility in water but depend on pH. As an example, chloride ions can be used to attack and dissolve E-glass. As an example, a polymeric material may be selected based at least in part on battery chemistry (e.g., chemistry of a lithium-ion cell or cells). As an example, some polymers may be stable in acidic environments, in basic environments or in acidic and basic environments.

As an example, a composite material may be formed of a polymer and another material that is not an organic-based polymer. As an example, a composite material may be formed of a polymer and glass fiber.

Stiffness of fiberglass can depend on the stiffness of the glass fibers used. For example, fiberglass with fibers of E-glass with modulus 57 GPa will be less stiff than fiberglass using higher-strength S2-glass with modulus 94 GPa. Further, orientation of fibers can affect stiffness. Fibers may be unidirectional, bidirectional or multidirectional.

Table 1, below, includes some properties of some examples of glass fibers, as from a Technical Paper (AGY, Aiken, S.C., High Strength Glass Fibers, Pub. No. LIT-2006-111 R2 (02/06), 2006, which is incorporated by reference herein).

TABLE 1
Properties

| | Glass Type | | | | | | | |
|---|---|---|---|---|---|---|---|---|
| | A | C | D | E | ECR | AR | R | S-2 |
| Density | 2.44 | 2.52 | 2.11-2.14 | 2.58 | 2.72 | 2.70 | 2.54 | 2.46 |
| Tensile | 3310 | 3310 | 2415 | 3445 | 3445 | 3241 | 4135 | 4890 |
| Strength MPa | | | | | | | | |
| 23 C. | | | | | | | | |
| Young's | 68.9 | 68.9 | 51.7 | 72.3 | 80.3 | 73.1 | 85.5 | 86.9 |
| Modulus GPa | | | | | | | | |
| 23 C. | | | | | | | | |
| Elongation % | 4.8 | 4.8 | 4.6 | 4.8 | 4.8 | 4.4 | 4.8 | 5.7 |

As an example, fiberglass may be provided in the form of a cloth that can be referred to as a fiberglass fabric. As an example, fiberglass may be provided in the form of a mat that can be referred to as a fiberglass mat. As an example, fiberglass may be provided in the form of a sheet that can be referred to as a fiberglass sheet.

As an example, fiberglass fabric (e.g., cloth) can be pliable and utilized in a battery package material where bendability is required without substantial breaking of glass fibers. In contrast, a rigid sheet of fiberglass can be brittle in that bending causes substantial breaking of glass fibers. As an example, a fiberglass fabric may be an ultrathin fiberglass fabric (e.g., cloth) that is less than approximately 50 microns. Such a fiberglass fabric can be pliable, for example, as to being included in a package material (see, e.g., the package material 510 of FIG. 5).

Physical properties of glass fiber composite materials can be fiber dominant. For example, where resin and glass fiber are combined to make a composite material (e.g., fiberglass), performance may be characterized largely by individual fiber properties (e.g., together with weave, etc.). Fibrous reinforcement as in a composite material tends to provide load bearing capabilities.

The surface treatment chemistry of glass fiber can follow product function. Textile size chemistries based on starch or polyvinyl alcohol film formers are capable in weaving, braiding, or knitting processes. A weaver may then scours or heat clean glass fabric and apply a finish compatible with the end product. Nonwoven size chemistries often include dispersants compatible with white water chemistry for wet formed mats or additives compatible with dry or wet binder chemistry for dry formed mats. Reinforcement size chemistries can be compatible with a multitude of processes and with the composite material end use performance criteria. Processes such as injection molding require chopped fibers with compatibility for thermoplastic compounds. Filament winding and pultrusion require continuous fibers with utility in thermoset and thermoplastic compounds. Components used with high strength glass size chemistries can include: a film former, lubricant, and coupling agent.

Application of glass fiber composite materials can depend on utilization of glass composition, size chemistry, fiber orientation, and fiber volume in the appropriate matrix for desired mechanical, electrical, thermal, and/or other properties.

As an example, a battery package may be subjected to one or more testing protocols to measure one or more properties. For example, consider the UN/DOT 38.3 Lithium Battery Testing protocols. One testing protocol involves an impact test that involves placing a battery package on a surface and placing a 15.8 mm diameter bar on the battery package followed by impact by a 9.1 kg mass, with force of a drop height of 61 cm, for a kinetic energy of 54.4 J. Such a test can be repeated a number of times (e.g., 5 times) where cells are to be at 50% of rated state of charge (SOC).

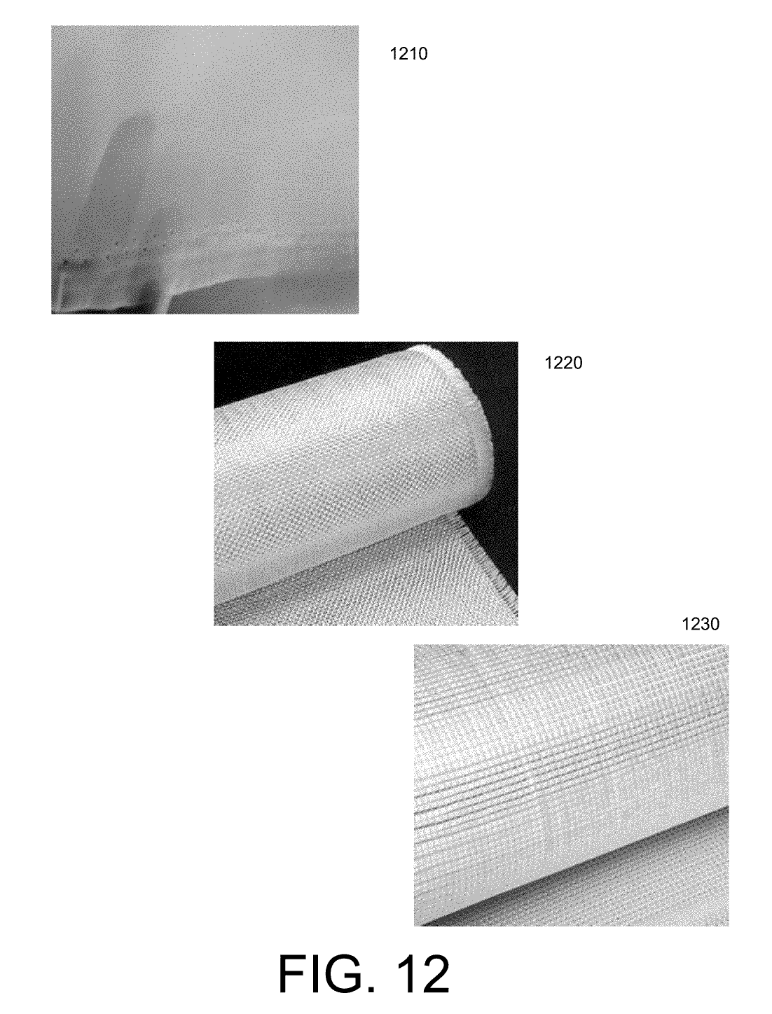

As an example, a fiberglass fabric can be pliable and possess some amount of transparency to light. As an example, a fiberglass fabric can be less than approximately 50 microns in thickness. Such a fiberglass fabric may possess transparency in that it can be see-through (e.g., transmit light, see, e.g., fiberglass 1210 of FIG. 12 where fingers can be seen through the fiberglass 1210).

As an example, consider a Style #106 0.75 oz. fiberglass cloth, which can be a plain weave, 1.2 mils thick (e.g., approximately 30 microns thick), VOLAN finish and warp 56, fill 56. VOLAN promotor (Cr (III) Methacrylate Surface Active Agent) may be utilized with one or more types of resins (e.g., polyesters, epoxies, phenolics, vinyls, acrylics, etc.) to form a composite material that includes glass fibers, which can be referred to as a fiberglass. As an example, a cloth of glass fiber with a VOLAN finish may be utilized with a type of resin to achieve a desired composite fiberglass.

As an example, another type of fiberglass cloth is Style #108 1.5 oz. fiberglass cloth, which can be a plain weave, 2.2 mils thick (e.g., 56 microns thick), with a VOLAN finish and warp 60, fill 47. As an example, a fiberglass cloth may be less than approximately 1.5 oz. or less than approximately 1 oz. or less than approximately 0.75 oz. or less than approximately 0.5 oz.

A fiberglass may be, for example, an Orca Composite fiberglass (OC001, 2, 3, 4, etc.)) or a “style” fiberglass (e.g., #104, #106, #108, etc.). As an example, a Style #104 can be approximately 0.58 oz. as a fabric weight per square yard (e.g., also consider #106 as being 0.73 oz., #108 as being 1.43 oz., #112, etc.).

As an example, as a composite material, a fiberglass may be made rigid via use of particular glass fiber and/or particular polymer (e.g., or polymers). For example, an ultrathin fiberglass may be made with a stiff fiber such that it becomes less pliable or even brittle. As an example, a sheet may be made with a stiff fiber that can be utilized as a rigid support material (see, e.g., various types of glass fibers, etc.). As an example, a cloth of glass fiber may be treated with an adhesion promotor that promotes adhesion of a selected resin where such a resin may be selected to impart properties to a composite fiberglass, which may be utilized in a battery package. As an example, a combination of glass fiber (e.g., stiff or less stiff, weave, etc.) and resin (e.g., polymeric material) may be utilized for making a fiberglass that can be included in a battery package. As an example, a fiberglass can be pliable or a fiberglass can be rigid.

As an example, a fiberglass in a package material and/or a rigid fiberglass underneath a package material may provide for mechanical properties of a battery package that can be an increase over those of a battery package that does not include fiberglass or that can be substantially equivalent while allowing for a thinner battery package.

In FIG. 8, a scale is shown to describe some examples, which may be described with respect to thicknesses of layers, number of layers, ratios of thicknesses of layers, etc. As an example, the scale may be in microns or, for example, it may be a normalized scale as normalized to range from 0 to 85. As to the latter, consider a 100 micron thick package material where 100 microns is normalized to 85 (e.g., each increment being greater than one micron) or consider a 70 micron thick package material where 70 microns is normalized to 85 (e.g., each increment being less than one micron).

As to the example package material 810, it includes a PET layer, more than two fiberglass (FG) layers and a PP layer. As shown, the FG layers are disposed between the PET layer and the PP layer. As shown, three FG layers can be included that can be approximately 15 to 50 on the scale (e.g., 35 units of the 85 units, approximately 40 percent of the total thickness), while the PET layer is 15 units (e.g., approximately 18 percent of the total thickness and less than half of the total FG thickness) and the PP layer is 35 units (e.g., approximately 40 percent of the total thickness and approximately 100 percent of the total FG thickness). In the example package material 810, an individual FG layer may be approximately 8 units to approximately 15 units.

As to the example package material 820, it includes a PET layer, at least two fiberglass (FG) layers and a PP layer. As shown, the FG layers are disposed between the PET layer and the PP layer. As shown, two FG layers can be included that can be approximately 15 to 50 on the scale (e.g., 35 units of the 85 units, approximately 40 percent of the total thickness), while the PET layer is 15 units (e.g., approximately 18 percent of the total thickness and less than half of the total FG thickness) and the PP layer is 35 units (e.g., approximately 40 percent of the total thickness and approximately 100 percent of the total FG thickness). In the example package material 820, an individual FG layer may be approximately 15 units to approximately 25 units.

As to the example package material 830, it includes a PET layer, at one fiberglass (FG) layer and a PP layer. As shown, the FG layer is disposed between the PET layer and the PP layer. As shown, the FG layer can be approximately 15 to 50 on the scale (e.g., 35 units of the 85 units, approximately 40 percent of the total thickness), while the PET layer is 15 units (e.g., approximately 18 percent of the total thickness and less than half of the total FG thickness) and the PP layer is 35 units (e.g., approximately 40 percent of the total thickness and approximately 100 percent of the total FG thickness). In the example package material 830, the individual FG layer may be approximately 25 units to approximately 45 units.

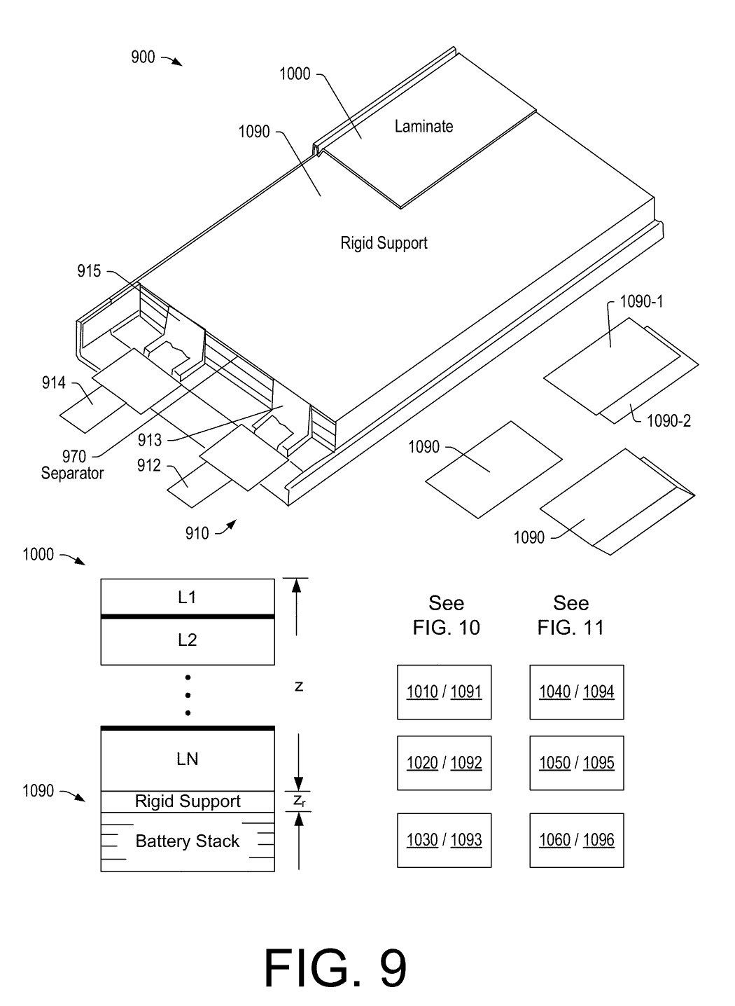

FIG. 9 shows an example of a battery package 900 that includes a battery 910, tabs 912 and 914 and electrical contact material 913 and 915, which are in electrical contact with anodes and cathodes and the tabs 912 and 914, respectively. Also shown in FIG. 9 is separator material 970, rigid support material 1090 and package material 1000, which includes various layers such that it is a laminate (e.g., a laminated package material). In FIG. 9, the rigid support material 1090 can encases the battery 910, which includes the separator material 970, and the package material 1000 encases the rigid support material 1090 and the battery 910.

As an example, the rigid support material 1090 may be utilized as a sheet disposed adjacent to one or more sides of the battery. For example, in the example of FIG. 9, two sheets of rigid support material 1090-1 and 1090-2 may be utilized where one sheet of rigid support material 1090-1 is placed on top of the battery 910 and another sheet of rigid support material 1090-2 is placed on the bottom of the battery 910. As an example, a U-shaped sheet of rigid support material 1090 may be utilized. As an example, a single sheet of rigid support material 1090 may be utilized where, for example, it is unfolded.

As an example, a jelly roll configuration of a battery can include one or more sheets of rigid support material such as, for example, rigid fiberglass and/or rigid polypropylene. For example, with reference to FIG. 1, one of the materials in the battery package can be a rigid support material. In such an example, upon rolling and/or folding to make a stack (e.g., of anodes and cathodes), a thickness of a battery can include one or more layers of rigid support material.

FIG. 9 shows some examples of package material 1010, 1020, 1030, 1040, 1050 and 1060 some examples of rigid support material 1091, 1092, 1093, 1094, 1095 and 1096. The package material 1000 of the battery package 900 can include, for example, one of 1010, 1020, 1030, 1040, 1050 and 1060 and the rigid support material 1090 of the battery package 900 can include one of 1091, 1092, 1093, 1094, 1095 and 1096, which may take one or more of various forms (e.g., unfolded, folded, encasing, etc.).

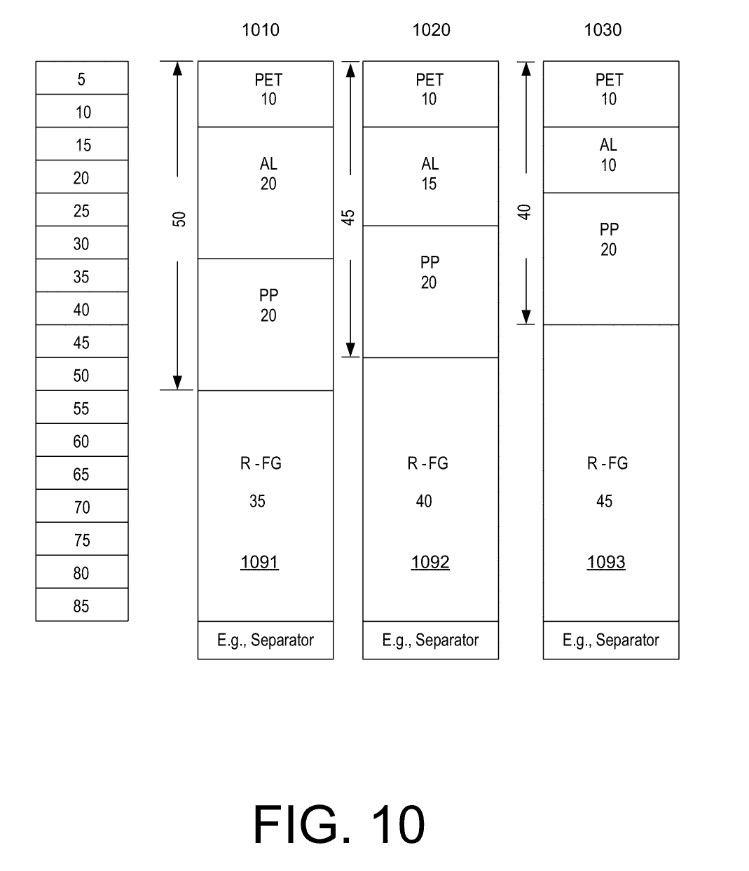

FIG. 10 shows package materials 1010, 1020 and 1030; noting that one or more additional materials may be included. For example, one or more adhesives may be included at one or more interfaces to bind material utilized. FIG. 10 also shows rigid support materials 1091, 1092 and 1093.

In FIG. 10, a scale is shown to describe some examples, which may be described with respect to thicknesses of layers, number of layers, ratios of thicknesses of layers, etc. As an example, the scale may be in microns or, for example, it may be a normalized scale as normalized to range from 0 to 85. As to the latter, consider a package material and rigid support material that is 100 microns thick where 100 microns is normalized to 85 (e.g., each increment being greater than one micron) or consider a package material and rigid support material that is 70 microns thick where 70 microns is normalized to 85 (e.g., each increment being less than one micron).

In the examples of FIG. 10, the package material 1010, 1020 and 1030 may be of a thickness that is less than approximately 100 microns and may be less than approximately 85 microns. For example, the package material 1010 may be approximately 50 microns, the package material 1020 may be approximately 45 microns and the package material 1030 may be approximately 40 microns; noting that one or more other thicknesses may be utilized, which may depend on thickness of rigid support material thickness, size and/or shape.

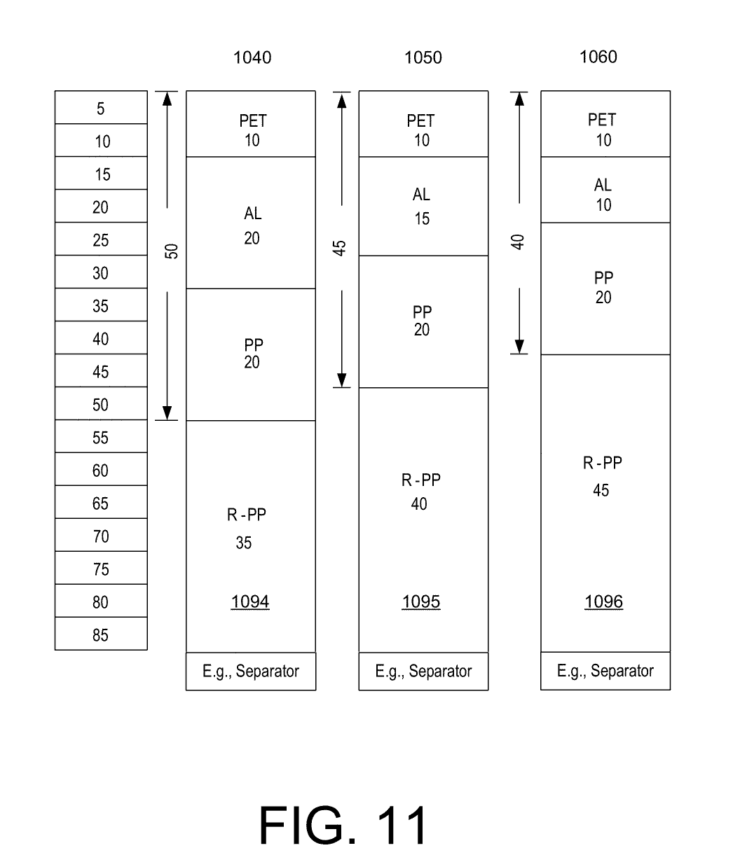

In the examples of FIG. 10 (and FIG. 9 and FIG. 11), through use of a rigid support material (see, e.g., the rigid support material 1090), the thickness of a laminate (see, e.g., the package material 1000) may be reduced. In such examples, the rigid support material can increase the structural integrity of a battery package such that the battery package can withstand applied force with a reduction in risk of damage to one or more of the package material and the battery packaged by the battery package. For example, the rigid support material may have a hardness that is greater than the hardness of one or more of the layers of the package material or than the package material. In such an approach, damage protection can be shifted to the rigid support material, for example, with respect to compressive force(s) that may be experienced by a battery package (e.g., during manufacture, during shipping, during installation in a device, during shipping of the device, during use of the device, during an accidental drop of the device, etc.).

As to the example package material 1010, it includes a PET layer, an aluminum (AL) layer, and a PP layer that can be adjacent to the rigid FG (R-FG) material 1091 layer (e.g., optionally with a material at the interface such as an adhesive). As shown, the package material 1010 is approximately 50 units thick while the R-FG material 1091 layer is approximately 35 units thick, for a total thickness of approximately 85 units. As to the package material 1010, the PET layer is an outermost layer and the PP layer is an innermost layer of the package material 1010 while the AL layer is disposed between the PET layer and the PP layer.

As shown, the R-FG layer can be approximately 35 on the scale (e.g., 35 units of the 85 units, approximately 40 percent of the total thickness), while the PET layer is 10 units (e.g., approximately 12 percent of the total thickness and less than one third of the R-FG thickness), the AL layer is 20 units (e.g., approximately 23.5 percent of the total thickness and approximately 57 percent of the thickness of the R-FG layer) and the PP layer is 20 units (e.g., approximately 23.5 percent of the total thickness and approximately 57 percent of the R-FG thickness).

As to the example package material 1020, it includes a PET layer, an aluminum (AL) layer, and a PP layer that can be adjacent to the rigid FG (R-FG) material 1092 layer (e.g., optionally with a material at the interface such as an adhesive). As shown, the package material 1020 is approximately 45 units thick while the R-FG material 1092 layer is approximately 40 units thick for a total thickness of approximately 85 units. As to the package material 1020, the PET layer is an outermost layer and the PP layer is an innermost layer of the package material 1020 while the AL layer is disposed between the PET layer and the PP layer.

As shown, the R-FG layer can be approximately 40 on the scale (e.g., 40 units of the 85 units, approximately 47 percent of the total thickness), while the PET layer is 10 units (e.g., approximately 12 percent of the total thickness and approximately one fourth of the R-FG thickness), the AL layer is 15 units (e.g., approximately 17.6 percent of the total thickness and approximately 37.5 percent of the thickness of the R-FG layer) and the PP layer is 20 units (e.g., approximately 23.5 percent of the total thickness and approximately 50 percent of the R-FG thickness).

As to the example package material 1030, it includes a PET layer, an aluminum (AL) layer, and a PP layer that can be adjacent to the rigid FG (R-FG) material 1093 layer (e.g., optionally with a material at the interface such as an adhesive). As shown, the package material 1030 is approximately 40 units thick while the R-FG material 1093 layer is approximately 45 units thick for a total thickness of approximately 85 units. As to the package material 1030, the PET layer is an outermost layer and the PP layer is an innermost layer of the package material 1030 while the AL layer is disposed between the PET layer and the PP layer.

As shown, the R-FG layer can be approximately 45 on the scale (e.g., 45 units of the 85 units, approximately 53 percent of the total thickness), while the PET layer is 10 units (e.g., approximately 12 percent of the total thickness and less than one fourth of the R-FG thickness), the AL layer is 10 units (e.g., approximately 12 percent of the total thickness and approximately 22 percent of the thickness of the R-FG layer) and the PP layer is 20 units (e.g., approximately 23.5 percent of the total thickness and approximately 44 percent of the R-FG thickness).

In the examples of FIG. 10, use of the R-FG material 1091, 1092 or 1093 can allow for a reduction in an amount of aluminum (Al, or AL). As shown, for a thicker rigid support material, a thinner layer of aluminum (Al, or AL) may be utilized.

FIG. 11 shows package materials 1040, 1050 and 1060; noting that one or more additional materials may be included. For example, one or more adhesives may be included at one or more interfaces to bind material utilized. FIG. 11 also shows rigid support materials 1094, 1095 and 1096.

In FIG. 11, a scale is shown to describe some examples, which may be described with respect to thicknesses of layers, number of layers, ratios of thicknesses of layers, etc. As an example, the scale may be in microns or, for example, it may be a normalized scale as normalized to range from 0 to 85. As to the latter, consider a package material and rigid support material that is 100 microns thick where 100 microns is normalized to 85 (e.g., each increment being greater than one micron) or consider a package material and rigid support material that is 70 microns thick where 70 microns is normalized to 85 (e.g., each increment being less than one micron).

In the examples of FIG. 11, the package material 1040, 1050 and 1060 may be of a thickness that is less than approximately 100 microns and may be less than approximately 85 microns. For example, the package material 1040 may be approximately 50 microns, the package material 1050 may be approximately 45 microns and the package material 1060 may be approximately 40 microns; noting that one or more other thicknesses may be utilized, which may depend on thickness of rigid support material thickness, size and/or shape.

In the examples of FIG. 11 (and FIG. 9 and FIG. 10), through use of a rigid support material (see, e.g., the rigid support material 1090), the thickness of a laminate (see, e.g., the package material 1000) may be reduced. In such examples, the rigid support material can increase the structural integrity of a battery package such that the battery package can withstand applied force with a reduction in risk of damage to one or more of the package material and the battery packaged by the battery package. For example, the rigid support material may have a hardness that is greater than the hardness of one or more of the layers of the package material or than the package material. In such an approach, damage protection can be shifted to the rigid support material, for example, with respect to compressive force(s) that may be experienced by a battery package (e.g., during manufacture, during shipping, during installation in a device, during shipping of the device, during use of the device, during an accidental drop of the device, etc.).

As to the example package material 1040, it includes a PET layer, an aluminum (AL) layer, and a PP layer that can be adjacent to the rigid PP (R-PP) material 1094 layer (e.g., optionally with a material at the interface such as an adhesive). As shown, the package material 1040 is approximately 50 units thick while the R-PP material 1094 layer is approximately 35 units thick, for a total thickness of approximately 85 units. As to the package material 1040, the PET layer is an outermost layer and the PP layer is an innermost layer of the package material 1040 while the AL layer is disposed between the PET layer and the PP layer.

As shown, the R-PP layer can be approximately 35 on the scale (e.g., 35 units of the 85 units, approximately 40 percent of the total thickness), while the PET layer is 10 units (e.g., approximately 12 percent of the total thickness and less than one third of the R-PP thickness), the AL layer is 20 units (e.g., approximately 23.5 percent of the total thickness and approximately 57 percent of the thickness of the R-PP layer) and the PP layer is 20 units (e.g., approximately 23.5 percent of the total thickness and approximately 57 percent of the R-PP thickness).

As to the example package material 1050, it includes a PET layer, an aluminum (AL) layer, and a PP layer that can be adjacent to the rigid PP (R-PP) material 1095 layer (e.g., optionally with a material at the interface such as an adhesive). As shown, the package material 1050 is approximately 45 units thick while the R-PP material 1095 layer is approximately 40 units thick for a total thickness of approximately 85 units. As to the package material 1050, the PET layer is an outermost layer and the PP layer is an innermost layer of the package material 1050 while the AL layer is disposed between the PET layer and the PP layer.

As shown, the R-PP layer can be approximately 40 on the scale (e.g., 40 units of the 85 units, approximately 47 percent of the total thickness), while the PET layer is 10 units (e.g., approximately 12 percent of the total thickness and approximately one fourth of the R-PP thickness), the AL layer is 15 units (e.g., approximately 17.6 percent of the total thickness and approximately 37.5 percent of the thickness of the R-PP layer) and the PP layer is 20 units (e.g., approximately 23.5 percent of the total thickness and approximately 50 percent of the R-PP thickness).

As to the example package material 1060, it includes a PET layer, an aluminum (AL) layer, and a PP layer that can be adjacent to the rigid PP material 1096 layer (R-PP) (e.g., optionally with a material at the interface such as an adhesive). As shown, the package material 1060 is approximately 40 units thick while the R-PP material 1096 layer is approximately 45 units thick for a total thickness of approximately 85 units. As to the package material 1060, the PET layer is an outermost layer and the PP layer is an innermost layer of the package material 1030 while the AL layer is disposed between the PET layer and the PP layer.

As shown, the R-PP layer can be approximately 45 on the scale (e.g., 45 units of the 85 units, approximately 53 percent of the total thickness), while the PET layer is 10 units (e.g., approximately 12 percent of the total thickness and less than one fourth of the R-PP thickness), the AL layer is 10 units (e.g., approximately 12 percent of the total thickness and approximately 22 percent of the thickness of the R-PP layer) and the PP layer is 20 units (e.g., approximately 23.5 percent of the total thickness and approximately 44 percent of the R-PP thickness).

In the examples of FIG. 11, use of the R-PP material 1094, 1095 or 1096 can allow for a reduction in an amount of aluminum (Al, or AL). As shown, for a thicker rigid support material, a thinner layer of aluminum (Al, or AL) may be utilized.

FIG. 12 shows three photographs of examples of fiberglass 1210, 1220 and 1230. The fiberglass 1210 may be utilized in the example 810 of FIG. 8 where the individual layers of fiberglass may be individual layers of the fiberglass 1210. The fiberglass 1220 may be utilized in the example 820 of FIG. 8 where the individual layers of fiberglass may be individual layers of the fiberglass 1220. The fiberglass 1230 may be utilized in the example 830 of FIG. 8 where the individual layer of fiberglass may be an individual layer of the fiberglass 1230.

Various examples of battery packages can include a metallic layer or be without a metallic layer. For example, FIG. 9 shows three examples of package material 810, 820 and 830 that do not include aluminum (e.g., or another metallic layer). Rather, in the examples of package material 810, 820 and 830 include fiberglass. As shown in the examples of FIG. 10 and FIG. 11, package material may include an aluminum layer where the aluminum layer is less than approximately 30 microns.

As an example, a battery package can include one or more of the package materials 810, 820 and 830 of FIG. 9 and can include one or more of the rigid support materials 1091, 1092, 1093, 1094, 1095 and 1096 of FIGS. 10 and 11.

As an example, a rigid polypropylene material can be formed of homo PP, random copolymer or block copolymer. As an example, a specific weight of a rigid polypropylene may be approximately 0.85 g/cm3 to approximately 0.95 g/cm³ (e.g., consider 0.91 g/cm³). As an example, a rigid polypropylene may be a medium barrier sheet that exhibits resistance to aqueous solutions, acids, bases and salts (e.g., chemistry of a lithium-ion cell). As an example, a high barrier sheet of multiple layers such as, for example, PP-EVOH-PP may be utilized where EVOH is Ethylene-Vinyl-Alcohol, which can be a gas barrier. Such a material can include one or more tie layers.

As an example, a rigid polypropylene may be a polypropylene, impact copolymer that is formed of propylene homopolymer containing a co-mixed propylene random copolymer phase which has an ethylene content of 45 percent to 65 percent (e.g., a PP impact copolymer).

As an example, a rigid support material can include polypropylene and fiberglass. For example, consider the 4PROP® 9C22420 heat stabilized polypropylene grade material that is reinforced with long glass fibers chemically coupled to a PP matrix.

As an example, PP may be, with the addition of one or more of modifiers, stabilizers, additives, etc., may be compounded or otherwise made to be impact modified, glass fiber reinforced, glass bead reinforced, mineral filled and reinforced, mica filled, carbon fiber reinforced, flame retardant, heat stabilized, scratch resistant, etc.

As an example, an impact test may be performed at room temperature according to ASTM ISO 179, Izod charpy tension impact test measurement test machines, XJU-22 Time group Inc. As an example, a hardness test may be performed using a durometer scale (ASTM D570, etc.).

As an example, PP is stronger and more rigid than both HDPE and LDPE. For a 10 mm×10 mm×4 mm sample of PP, a Shore D hardness may be about 75.

As an example, fiberglass may be included in a battery package as a creep resistant material. For example, where an applied force exists for an extended period of time (e.g., hours or days), a battery package can include an anti-creep material that resists (e.g., reduces) creep. Creep may cause thinning of one or more materials such that over time thinning may lead to a weaker region that may result in a puncture or opening in a layer. A material such as fiberglass can help to resist creep as fiberglass can be more resistant to creep than a polymeric material.

As an example, a battery package can include strength and rigidity for safety where the battery package can resist denting and puncturing. As an example, a battery package can include one or more hybrid layers with flexible polymeric materials and/or rigid polymeric materials. As an example, flexible polymeric materials (e.g., films) may be utilized with fiberglass (e.g., material that includes glass fibers). As an example, rigid polymeric materials (e.g., films, which may be sheets), can be utilized for making a battery package. As an example, a package material can be a laminate that may include aluminum. As an example, a package material may be a laminate that does not include aluminum.

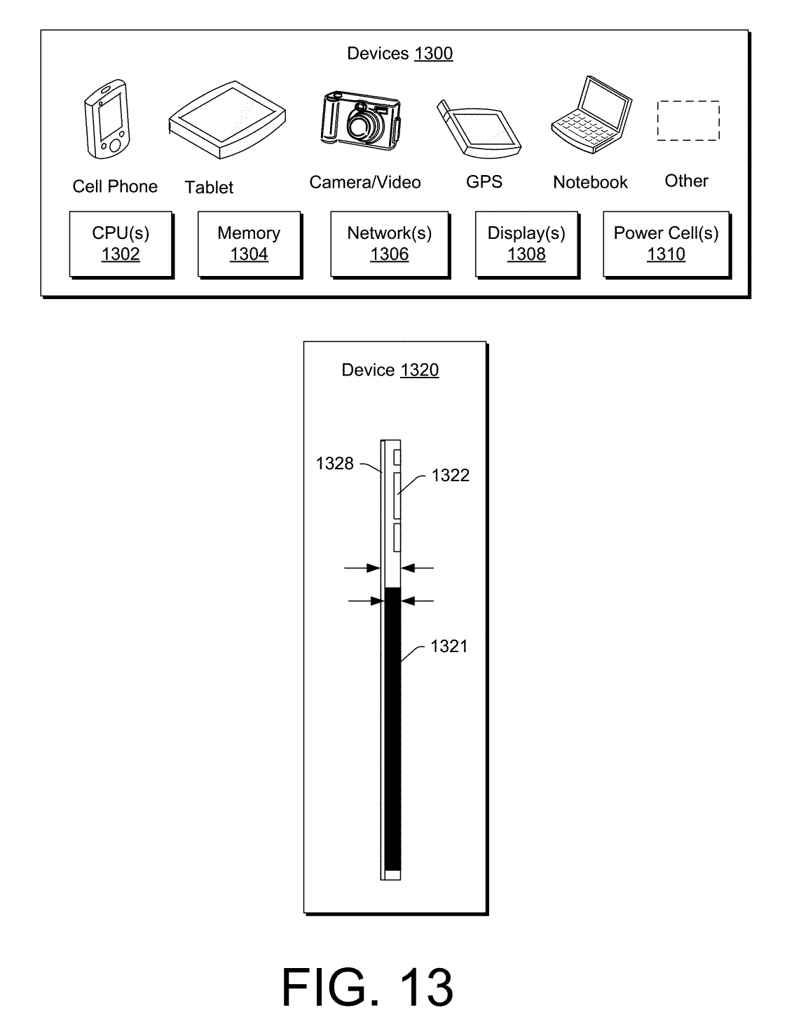

FIG. 13 shows some examples of devices 1300 that may be powered by a lithium-ion cell or cells (e.g., in the form of a lithium-ion battery or batteries). For example, a cell phone, a tablet, a camera, a GPS device, a notebook computer, or other device may be powered by a lithium-ion cell or cells. As to other devices, a device may be an electric motor of an electric vehicle or a hybrid vehicle. A device may be an automobile, a toy, a remote control device (e.g., a bomb sniffers, drones, etc.), etc. A device may include one or more processors 1302, memory 1304, one or more network interfaces 1306, one or more displays 1308 and, as a power source, one or more lithium-ion cells 1310.

As an example, a device 1320 may include a power cell(s) 1321, circuitry 1322 and, for example, a display 1328. In such an example, the thickness of the device 1320 may be determined largely by a thickness of the power cell(s) 1321. For example, about 80 percent of the overall thickness of the device 1320 may be determined by a thickness of the power cell(s) 1321 as determined by thickness of a battery package.

As an example, a battery package can include a battery that includes at least one lithium-ion cell; and a package material that includes at least one layer of fiberglass. In such an example, the package material can be a laminate. As an example, the laminate can be a laminate that does not include a layer of aluminum. As an example, a laminate may be free of a metallic layer (e.g., aluminum, stainless steel, etc.).

As an example, a battery package can include at least two layers of fiberglass. As an example, at least one layer of fiberglass can be of a thickness of less than approximately 40 microns and greater than approximately 20 microns. As an example, at least one layer of fiberglass can be of a thickness less than approximately 20 microns and greater than approximately 10 microns.

As an example, a package material can include a layer of polypropylene. As an example, a package material can include a layer of PET.

As an example, a battery package can include a package material where at least one of at least one layer of fiberglass is disposed between a layer of PET and a layer of polypropylene.

As an example, a battery package can include a battery that includes at least one lithium-ion cell and at least one layer of rigid support material; and a package material having a thickness less than approximately 60 microns and greater than approximately 30 microns. In such an example, the package material may include a layer of aluminum. For example, consider a layer of aluminum that has a thickness less than approximately 30 microns. As an example, consider a layer of aluminum that has a thickness less than approximately 25 microns and greater than approximately 5 microns.

As an example, a thickness of at least one layer of rigid support material of a battery package can have a thickness that is greater than the thickness of package material of the battery package. As an example, in a battery package, at least one of at least one layer of rigid support material may be adjacent to a layer of separator material of a battery of the battery package.

As an example, in a battery package, a rigid support material can include glass fibers and be separate from a package material. For example, the rigid support material can be a rigid fiberglass. As an example, a rigid support material can be or include rigid polypropylene, which can be separate from a package material.

As an example, a device can include a processor; memory accessible by the processor; a housing that comprises a battery bay that includes a first surface and a second, opposing surface; and a battery package disposed in the battery bay and operatively coupled to the processor wherein the battery package includes a support material. In such an example, the support material can be or include a rigid support material. A device can include one or more battery packages that can include a battery that includes at least one lithium-ion cell; and a package material that includes at least one layer of fiberglass and/or one or more battery packages that can include a battery that includes at least one lithium-ion cell and at least one layer of rigid support material; and a package material having a thickness less than approximately 60 microns and greater than approximately 30 microns.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory card, a storage disk, etc.) and referred to as a computer-readable storage medium. As an example, a computer-readable medium may be a computer-readable medium that is not a carrier wave.

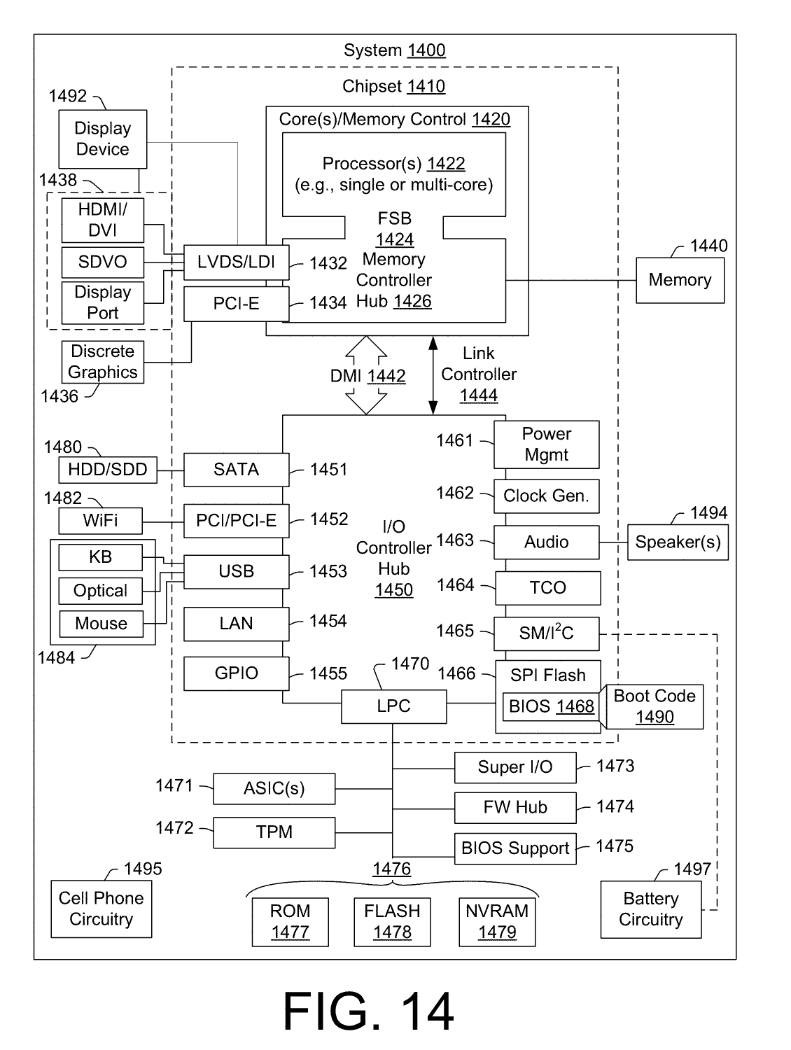

While various examples of circuits or circuitry have been discussed, FIG. 14 depicts a block diagram of an illustrative computer system 1400. The system 1400 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 1400. As described herein, a device such as in FIG. 2, FIG. 3, FIG. 13, etc., may include at least some of the features of the system 1400.

As shown in FIG. 14, the system 1400 includes a so-called chipset 1410. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 14, the chipset 1410 has a particular architecture, which may vary to some extent depending on brand or manufacturer. The architecture of the chipset 1410 includes a core and memory control group 1420 and an I/O controller hub 1450 that exchange information (e.g., data, signals, commands, etc.) via, for example, a direct management interface or direct media interface (DMI) 1442 or a link controller 1444. In the example of FIG. 14, the DMI 1442 is a chip-to-chip interface (sometimes referred to as being a link between a “northbridge” and a “southbridge”).

The core and memory control group 1420 include one or more processors 1422 (e.g., single core or multi-core) and a memory controller hub 1426 that exchange information via a front side bus (FSB) 1424. As described herein, various components of the core and memory control group 1420 may be integrated onto a single processor die, for example, to make a chip that supplants the conventional “northbridge” style architecture.

The memory controller hub 1426 interfaces with memory 1440. For example, the memory controller hub 1426 may provide support for DDR SDRAM memory (e.g., DDR, DDR2, DDR3, etc.). In general, the memory 1440 is a type of random-access memory (RAM). It is often referred to as “system memory”.

The memory controller hub 1426 further includes a low-voltage differential signaling interface (LVDS) 1432. The LVDS 1432 may be a so-called LVDS Display Interface (LDI) for support of a display device 1492 (e.g., a CRT, a flat panel, a projector, etc.). A block 1438 includes some examples of technologies that may be supported via the LVDS interface 1432 (e.g., serial digital video, HDMI/DVI, display port). The memory controller hub 1426 also includes one or more PCI-express interfaces (PCI-E) 1434, for example, for support of discrete graphics 1436. Discrete graphics using a PCI-E interface has become an alternative approach to an accelerated graphics port (AGP). For example, the memory controller hub 1426 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1450 includes a variety of interfaces. The example of FIG. 14 includes a SATA interface 1451, one or more PCI-E interfaces 1452 (optionally one or more legacy PCI interfaces), one or more USB interfaces 1453, a LAN interface 1454 (more generally a network interface), a general purpose I/O interface (GPIO) 1455, a low-pin count (LPC) interface 1470, a power management interface 1461, a clock generator interface 1462, an audio interface 1463 (e.g., for speakers 1494), a total cost of operation (TCO) interface 1464, a system management bus interface (e.g., a multi-master serial computer bus interface) 1465, and a serial peripheral flash memory/controller interface (SPI Flash) 1466, which, in the example of FIG. 14, includes BIOS 1468 and boot code 1490. With respect to network connections, the I/O hub controller 1450 may include integrated gigabit Ethernet controller lines multiplexed with a PCI-E interface port. Other network features may operate independent of a PCI-E interface.

The interfaces of the I/O hub controller 1450 provide for communication with various devices, networks, etc. For example, the SATA interface 1451 provides for reading, writing or reading and writing information on one or more drives 1480 such as HDDs, SDDs or a combination thereof. The I/O hub controller 1450 may also include an advanced host controller interface (AHCI) to support one or more drives 1480. The PCI-E interface 1452 allows for wireless connections 1482 to devices, networks, etc. The USB interface 1453 provides for input devices 1484 such as keyboards (KB), one or more optical sensors, mice and various other devices (e.g., microphones, cameras, phones, storage, media players, etc.). On or more other types of sensors may optionally rely on the USB interface 1453 or another interface (e.g., I²C, etc.). As to microphones, the system 1400 of FIG. 14 may include hardware (e.g., audio card) appropriately configured for receipt of sound (e.g., user voice, ambient sound, etc.).

In the example of FIG. 14, the LPC interface 1470 provides for use of one or more ASICs 1471, a trusted platform module (TPM) 1472, a super I/O 1473, a firmware hub 1474, BIOS support 1475 as well as various types of memory 1476 such as ROM 1477, Flash 1478, and non-volatile RAM (NVRAM) 1479. With respect to the TPM 1472, this module may be in the form of a chip that can be used to authenticate software and hardware devices. For example, a TPM may be capable of performing platform authentication and may be used to verify that a system seeking access is the expected system.

The system 1400, upon power on, may be configured to execute boot code 1490 for the BIOS 1468, as stored within the SPI Flash 1466, and thereafter processes data under the control of one or more operating systems and application software (e.g., stored in system memory 1440). An operating system may be stored in any of a variety of locations and accessed, for example, according to instructions of the BIOS 1468. Again, as described herein, a satellite, a base, a server or other machine may include fewer or more features than shown in the system 1400 of FIG. 14. Further, the system 1400 of FIG. 14 is shown as optionally include cell phone circuitry 1495, which may include GSM, CDMA, etc., types of circuitry configured for coordinated operation with one or more of the other features of the system 1400. Also shown in FIG. 14 is battery circuitry 1497, which may provide one or more battery, power, etc., associated features (e.g., optionally to instruct one or more other components of the system 1400). As an example, a SMBus may be operable via a LPC (see, e.g., the LPC interface 1470), via an I²C interface (see, e.g., the SM/I²C interface 1465), etc.

### CONCLUSION

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A battery package comprising:
a battery that comprises at least one lithium-ion cell; and
a package material that comprises at least one layer of fiberglass.

2. The battery package of claim 1 wherein the package material is a laminate.

3. The battery package of claim 2 wherein the laminate does not include a layer of aluminum.

4. The battery package of claim 1 comprising at least two layers of fiberglass.

5. The battery package of claim 1 wherein the at least one layer of fiberglass comprises a thickness of less than approximately 40 microns and greater than approximately 20 microns.

6. The battery package of claim 1 wherein the at least one layer of fiberglass comprises at least one layer of fiberglass having a thickness less than approximately 20 microns and greater than approximately 10 microns.

7. The battery package of claim 1 wherein the package material comprises a layer of polypropylene.

8. The battery package of claim 1 wherein the package material comprises a layer of PET.

9. The battery package of claim 1 wherein at least one of the at least one layer of fiberglass is disposed between a layer of PET and a layer of polypropylene.

10. A battery package comprising:
a battery that comprises at least one lithium-ion cell and at least one layer of rigid support material; and
a package material having a thickness less than approximately 60 microns and greater than approximately 30 microns.

11. The battery package of claim 10 wherein the package material comprises a layer of aluminum.

12. The battery package of claim 11 wherein the layer of aluminum has a thickness less than approximately 30 microns.

13. The battery package of claim 11 wherein the layer of aluminum has a thickness less than approximately 25 microns and greater than approximately 5 microns.

14. The battery package of claim 10 wherein the thickness of the at least one layer of rigid support material has a thickness that is greater than the thickness of the package material.

15. The battery package of claim 10 wherein at least one of the at least one layer of rigid support material is adjacent to a layer of separator material of the battery.

16. The battery package of claim 10 wherein the rigid support material comprises glass fibers.

17. The battery package of claim 10 wherein the rigid support material comprises rigid polypropylene.

18. The battery package of claim 10 wherein the rigid support material comprises rigid fiberglass.

19. A device comprising:
a processor;
memory accessible by the processor;
a housing that comprises a battery bay that comprises a first surface and a second, opposing surface; and
a battery package disposed in the battery bay and operatively coupled to the processor wherein the battery package comprises a support material.

20. The device of claim 19 wherein the support material comprises a rigid support material.
